(19) United States
(12) Patent Application Publication
(10) Pub. No.: US 2019/0332755 A1
(43) Pub. Date: Oct. 31, 2019

(54) SECURE CHIP, BIOLOGICAL FEATURE IDENTIFICATION METHOD, AND BIOLOGICAL FEATURE TEMPLATE REGISTRATION METHOD

(71) Applicants: Chipone Technology (Beijing) Co., Ltd., Beijing (CN); Chipone System Technology (Beijing) Co., Ltd., Beijing (CN)

(72) Inventors: Kun Li, Beijing (CN); Dong Xu, Beijing (CN); Lei Fan, Beijing (CN); Jinfang Zhang, Beijing (CN)

(21) Appl. No.: 16/309,255

(22) PCT Filed: Jun. 9, 2017
(86) PCT No.: PCT/CN2017/087778

§ 371 Date: Dec. 12, 2018

(30) Foreign Application Priority Data
Jun. 12, 2016 (CN) 201610412982.4

(51) Int. Cl. G06F 21/32

(52) U.S. Cl. CPC G06F 21/32

(57) ABSTRACT

A security chip, a biometric recognition method and a biometric template registration method are disclosed herein. The security chip comprises: a sensor configured to sensor information of a biometric feature; a memory configured to store a template of the biometric feature; a processor configured to obtain the information of the biometric feature from the sensor, perform image preprocessing and feature extraction on the obtained information of the biometric feature, compare features with the template of the biometric feature stored in the memory to determine a biometric recognition result, wherein the template of the biometric feature is generated by the processor by obtaining the information of the biometric feature from the sensor and performing image preprocessing and feature extraction on the obtained information of the biometric feature, and the sensor, the memory and the processor are integrated in the security chip. The sensing, storage and processing of the information relative to the biometric feature are all performed in the security chip, and physically isolated from the system environment, so that, the security is greatly improved compared to traditional logical isolation.

### CROSS-REFERENCE TO RELATED APPLICATION

This application claims the benefit of Chinese Patent Application No. 201610412982.4, filed on Jun. 12, 2016, entitled as ‘security chip, biometric recognition method and biometric template registration method’, which is incorporated herein by reference in its entirety.

### BACKGROUND OF THE DISCLOSURE

### Field of the Disclosure

The present disclosure relates to the field of biometric recognition technology, and more particularly, to a security chip, a biometric recognition method and a biometric template registration method.

### Description of the Related Art

Biometric features, such as fingerprints, irises, and faces, are increasingly used in the field of identity authentication due to their uniqueness, privacy, and unchangeability. In traditional biometric recognition schemes, stored templates of biometric features each contain a large amount of original biometric information, and even some templates are biometric images. Once a template is lost or stolen, an intruder can directly use the information included in the template to pass verification, and further implement cross-verification among databases of different applications, for example, fingerprint template information stolen from a fingerprint access control system can be used to invade a corresponding fingerprint-authenticated personal bank account. A corresponding biometric sample can even be forged directly from a specific template of a biometric feature, for example, a corresponding fingerprint may be forged from a fingerprint minutiae template. Meanwhile, due to the unchangeability of biometric features, once the original information is revealed, the resulting damage will be permanent and extensive. Therefore, the protection for the biometric templates in a biometric recognition system is very important.

Currently, Trust Zone security technique (or Secure Enclave security technique) is commonly used in computing devices such as smart phones and tablet computers adopting IOS or Android systems, which logically divide system environment into security zones and non-security zones, and the registration and recognition of the biometric feature are performed in the security zone. However, the division of security zones and non-security zones is purely logical, the information relative to the biometric feature is still easy to be stolen during the processes of transmission, storage and calculation, and as a result, the overall security level of biometric recognition is still not strong enough.

### SUMMARY OF THE DISCLOSURE

The embodiments of the present invention provide a security chip, a biometric recognition method and a biometric template registration method, for improving the security of biometric recognition.

On one aspect of the disclosure, there is provided a security chip, comprising: a sensor for sensing information of a biometric feature; a memory configured to store a template of the biometric feature; a processor configured to obtain the information of the biometric feature from the sensor, perform image preprocessing and feature extraction on the obtained information of the biometric feature, compare features with the template of the biometric feature stored in the memory to determine a biometric recognition result, wherein the template of the biometric feature is generated during a registration phase by the processor by obtaining the information of the biometric feature from the sensor and performing image preprocessing and feature extraction on the obtained information of the biometric feature, and the sensor, the memory and the processor are integrated in the security chip.

In some embodiments, the processor comprises: an image obtaining module configured to obtain the information of the biometric feature from the sensor; an image preprocessing module configured to preprocess the information of the biometric feature obtained by the image obtaining module to obtain a grayscale image of the biometric feature; a feature extraction module configured to extract biometric points of the biometric feature from the grayscale image provided by the image preprocessing module to obtain biometric data relative to the biometric points; and a feature comparison module configured to compare the biometric data provided by the feature extraction module with the template of the biometric feature stored in the memory and determine the biometric recognition result that if the biometric data matches the template of the biometric feature, the biometric recognition result is passing, and otherwise, the biometric recognition result is failing.

In some embodiments, the processor further comprises a signature module configured to digitally sign the biometric recognition result.

In some embodiments, the security chip is a security element SE.

In some embodiments, the security chip is installed in a computing device and is physically isolated from a system environment of the computing device.

In some embodiments, the system environment of the computing device is divided into security zones and non-security zones, and the security chip sends the biometric recognition result to the computing device through the security zones or the non-security zones.

In some embodiments, the biometric feature comprises a fingerprint, the information of the biometric feature comprises image information of the fingerprint, and the biometric data comprises feature point data of the fingerprint, the template of the biometric feature includes a template of the fingerprint.

On another aspect, there is provided a biometric recognition method, comprising following steps performed in a single security chip: sensing information of a biometric feature in accordance with a biometric recognition instruction; obtaining the sensed information of the biometric feature; performing image preprocessing and feature extraction on the obtained information of the biometric feature to obtain biometric data; and comparing the biometric data with a template of the biometric feature stored in the security chip to determine a biometric recognition result.

In some embodiments, the biometric recognition method further comprises: digitally signing the biometric recognition result in the security chip.

On another aspect, there is provided a biometric template registration method, comprising following steps performed in a single security chip: sensing information of a biometric feature in accordance with a biometric template registration instruction; obtaining the sensed information of the biometric feature; performing image preprocessing and feature extraction on the obtained information of the biometric feature to obtain biometric data; and storing the biometric data in the security chip as a template of the biometric feature.

### BRIEF DESCRIPTION OF THE DRAWINGS

In order to explain the technical solutions according to the embodiments of the present disclosure more clearly, drawings of the embodiments will be briefly described in the following description. Obviously, the drawings in the following description only relate to some embodiments of the present disclosure, and are not intended to limit the disclosure.

FIG. 1 shows a block diagram of a security chip according to an embodiment of the present disclosure.

FIG. 2 shows a block diagram of a security chip according to an embodiment of the present disclosure.

FIG. 3 shows a diagram of a biometric recognition method according to an embodiment of the present disclosure.

FIG. 4 shows a diagram of a biometric template registration method according to an embodiment of the present disclosure.

### DETAILED DESCRIPTION OF THE DISCLOSURE

To make the objectives, technical solutions, and advantages of the embodiments of the present disclosure clearer, the technical solutions of the embodiments of the present disclosure will be described clearly and completely in connection with the drawings of the embodiments of the present disclosure. Obviously, the following embodiments are only some embodiments of the present disclosure and not all embodiments. All other embodiments obtained by an ordinary skilled in the art based on the described embodiments of the present disclosure without creative efforts shall fall within the protection scope of the present disclosure.

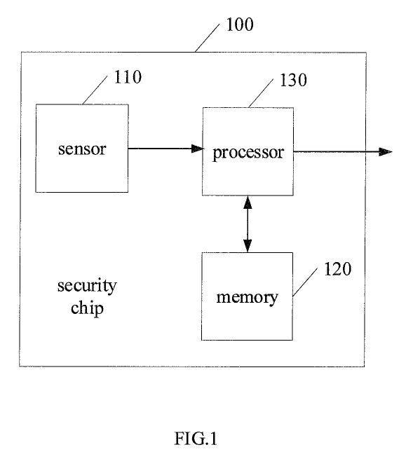

FIG. 1 shows a block diagram of a security chip 100 according to an embodiment of the present disclosure. As shown in FIG. 1, the security chip 100 includes a sensor 110, a memory 120, and a processor 130. The sensor 110, the memory 120, and the processor 130 are integrated in the security chip. The sensor 110 is used to sense information of a biometric feature. The memory 120 is used to store a template of the biometric feature. The processor 130 is used to acquire information of the biometric feature from the sensor 110, perform image preprocessing and feature extraction on the acquired information of the biometric feature, and compare features with the template stored in the memory 120 to determine a biometric recognition result. The template of the biometric feature is generated in a registration phase by the processor 130 by acquiring the information of the biometric feature from the sensor 110 and performing image preprocessing and feature extraction on the acquired information of the biometric feature.

In some embodiments, the processor 130 may include an image obtaining module for obtaining the information of the biometric feature from the sensor 110, an image preprocessing module for preprocessing the information of the biometric feature obtained by the image obtaining module to obtain a grayscale image of the biometric feature; a feature extraction module for extracting biometric points of the biometric feature from the grayscale image obtained by the image preprocessing module to obtain biometric data relative to the biometric points; and a feature comparison module for comparing the biometric data obtained by the feature extraction module with the template of the biometric feature stored in the memory 120 and determining the biometric recognition result, wherein if the biometric data matches a template of the biometric feature, the biometric recognition result is passing, and otherwise, the biometric recognition result is failing.

In some embodiments, the processor 130 may also include a signature module for digitally signing the biometric recognition result.

In some embodiments, the security chip 100 may be a security element SE.

In some embodiments, the security chip 100 may be installed in a computing device and physically isolated from a system environment of the computing device.

In some embodiments, the system environment of the computing device may be divided into security zones and non-security zones and the security chip 100 sends the biometric recognition result to the computing device through the security zones or the non-security zones.

In some embodiments, the biometric feature includes a fingerprint, the information of the biometric feature includes image information of the fingerprint, the biometric data includes feature point data of the fingerprint, and the template of the biometric feature includes the template of the fingerprint.

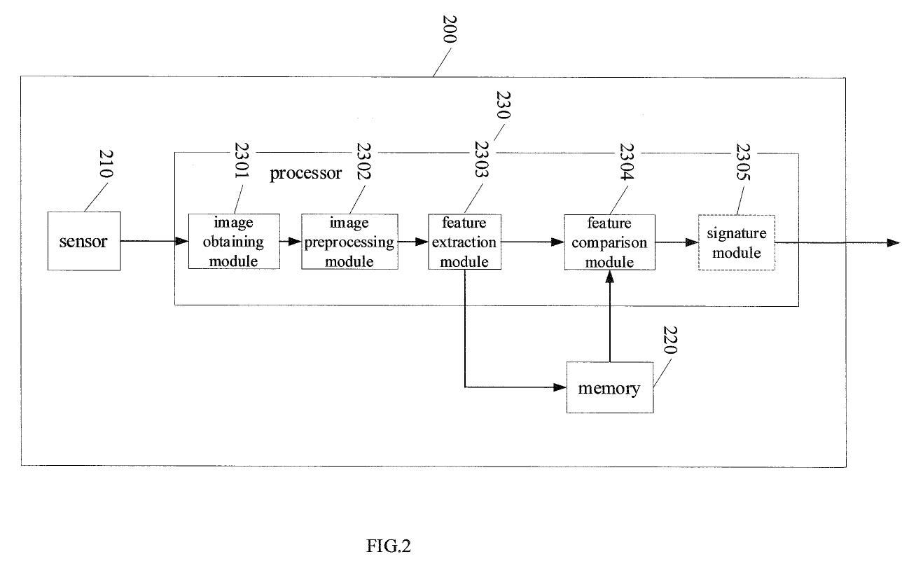

FIG. 2 shows a block diagram of a security chip according to an embodiment of the present disclosure. The embodiment of the disclosure is applicable to the recognition of one or more biometric features, examples of the biometric features include but are not limited to textures (including fingerprints, palm prints, veins and related accessory features such as sweat holes), biofilms (e.g., iris, retina, etc.), faces, ear canals, voices, body shapes, personal habits (such as the strength and frequency of keystrokes, signature, gait), etc. In the embodiment, the biometric feature can be for example, a fingerprint.

As shown in FIG. 2, the security chip 200 includes a sensor 210, a memory 220, and a processor 230. The sensor 210, the memory 220, and the processor 230 are integrated in the security chip 200. In some embodiments, the security chip 200 can be SE.

The sensor 210 is used to sense information of a biometric feature. The information of the biometric feature can include information relative to one or more biometric features such as textures (including fingerprints, palm prints, veins and related accessory features such as sweat holes), biofilms (e.g., iris, retina, etc.), faces, ear canals, voices, body shapes, personal habits (such as the strength and frequency of keystrokes, signature, gait), etc. For fingerprint recognition, for example, the information of the biometric feature can include image information of fingerprints. In the embodiment of the disclosure, the sensor 210 can be an optical sensor, a semiconductor sensor, an ultrasonic sensor, a radio frequency identification sensor or any sensor that can sense the information of the biometric feature.

The memory 220 is used to store a template of the biometric feature. The template may be generated by the processor 230 in a registration phase by acquiring the information of the biometric feature from the sensor 210 and performing image preprocessing and feature extraction on the acquired information of the biometric feature. In the embodiment, a memory 220 may be a non-volatile memory, such as a flash memory, an electrically erasable programmable read only memory (EEPROM), erasable programmable read only memory (EPROM), programmable read only memory (PROM), or other magnetic or electrical storage medias where data can continue to be retained in the condition of power failure.

The processor 230 is used to obtain the information of the biometric feature from the sensor 210, perform image preprocessing and feature extraction on the obtained information of the biometric feature, and compare features with the template stored in the memory 220 to determine the biometric recognition result.

In some embodiments, the processor 230 may include an image obtaining module 2301, an image preprocessing module 2302, a feature extraction module 2303, and a feature comparison module 2304. Alternatively, the processor 230 may also include a signature module 2305.

The image obtaining module 2301 is used to obtain the information of the biometric feature from the sensor 210. For example, for a fingerprint, the image obtaining module 2201 may obtain the image information of the fingerprint from the sensor 210 one or more times by a sliding acquisition mode or a pressure acquisition mode.

The image preprocessing module 2302 is used to preprocess the information of the biometric feature acquired by the image obtaining module 2301 to obtain a grayscale image of the biometric feature. For example, for a fingerprint image, the preprocessing may include, for example, image normalization, fingerprint effective area segmentation and processing, fingerprint direction map processing, fingerprint enhancement processing, fingerprint binarization processing, and fingerprint refinement processing and the like.

The feature extraction module 2303 is used to extract the biometric points from the grayscale image obtained by the image preprocessing module 2302 to obtain the biometric data related to the biometric points. For example, the biometric data may include the biometric point data of a fingerprint. In the registration phase of the biometric template, the generated biometric data is stored in the memory 1201 as a template of the biometric feature.

The feature comparison module 2304 is used to compare the biometric data obtained by the feature extraction module 2303 with the biometric template stored in the memory 220, and determine the biometric recognition result, wherein if the biometric data matches the template of the biometric feature, the biometric recognition result is passing, and otherwise, the biometric recognition result is failing.

The signature module 2305 is used to provide digital signature for the biometric recognition result. In some embodiments, providing the digital signature may include: generating a key pair including a public key and a private key after the registration of the template of the biometric feature is successful, storing the private key in the security chip 200 (e.g., stored in the memory 220), sending the public key to the external of the security chip 200 and digitally signing the biometric recognition result by using the private key after the biometric recognition result is determined. For example, the security chip 200 may generate the key pair after the registration of the template is successful, then store the private key in the security chip 200 and send the public key to an application server via an application terminal where the security chip 200 is located, such as a smartphone or a tablet computer installed with the security chip 200. After the security chip 200 determines the biometric recognition result, it may use the private key stored therein to sign the biometric recognition result, and send the signed biometric recognition result to the application server via the application terminal where the security chip is located. The application server uses the corresponding public key to verify the legitimacy of the signed biometric result.

In some embodiments, the security chip 200 may be installed in a computing device such as a smart phone or tablet computer, and is physically isolated from the system environment of the computing device. The system environment of the computing device may be divided into security zones and non-security zones (for example, a smartphone or a tablet computer using Trust Zone security technique or Secure Enclave security technique), and the biometric recognition result provided by the security chip 200 may be transmitted in the non-security zones of the computing device to simplify the operation, or transmitted in the security zones of the computing device for further improving the security. Certainly, the security chip 200 can also be installed in a computing device that is not divided into security zones and non-security zones. It can be seen that the embodiments of the present disclosure are applicable to various existing computing devices such as smart phones, tablet computers, and thus it has high compatibility.

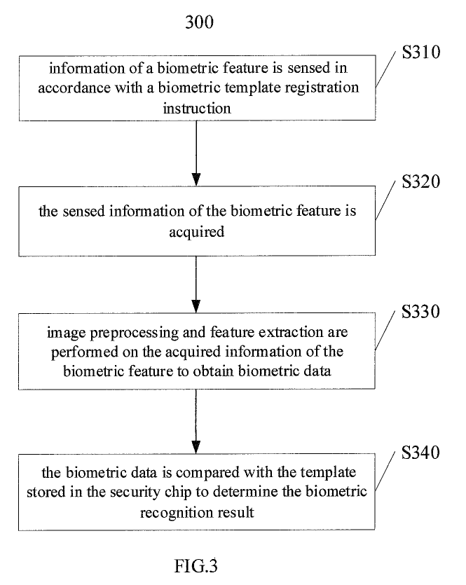

FIG. 3 shows a diagram of a biometric recognition method 300 according to an embodiment of the present disclosure. The method 300 may be entirely performed in a single security chip, such as the security chips 100 and 200 described above. The security chip may be installed in a computing device such as a smart phone, a tablet computer and the like, and physically isolated from the system environment of the computing device.

In step S310, information of a biometric feature, such as image information of a fingerprint, is sensed in accordance with a biometric template registration instruction. The biometric template recognition instruction can be provided by a computing device such as a smart phone, tablet computer, or the like.

In step S320, the sensed information of the biometric feature is acquired.

In step S330, image preprocessing and feature extraction are performed on the acquired information of the biometric feature to obtain biometric data. For example, the acquired information of the biometric feature may be preprocessed (e.g., image normalization, fingerprint effective area segmentation processing, fingerprint orientation processing, fingerprint enhancement processing, fingerprint binarization processing, fingerprint refinement processing, etc.) to obtain a grayscale image of the biometric feature, extract biometric points from the obtained grayscale image to obtain biometric data related to the biometric points (e.g., biometric point data of a fingerprint).

In step S340, the biometric data is compared with the template (for example, a template of a fingerprint) stored in the security chip to determine the biometric recognition result. For example, if the biometric data matches a template of the biometric feature, it is determined that the biometric recognition result is passing, and otherwise, the biometric recognition result is failing.

In some embodiments, the template of the biometric feature, such as a template of a fingerprint, may be generated by the processor of the security chip by processing the steps S320 and S330 during a registration phase, and stored in the memory of the security chip, such as a non-volatile memory. Examples of non-volatile memory include, but are not limited to a flash memory, an electrically erasable programmable read only memory (EEPROM), an erasable programmable read only memory (EPROM), a programmable read only memory (PROM), or other magnetic or electrical storage medias where data can continue to be retained in the condition of power failure.

In some embodiments, the method 300 may further include digitally signing the biometric result by the security chip, for example, the digital signature described above.

In some embodiments, the method 300 may further include sending the biometric recognition result to the computing device. As an example, for a computing device such as a smart phone, tablet computer or the like using Trust Zone security technique or Secure Enclave security technique, the unsigned or signed biometric recognition result can be sent to the computing device through the security zones or non-security zones of the computing device.

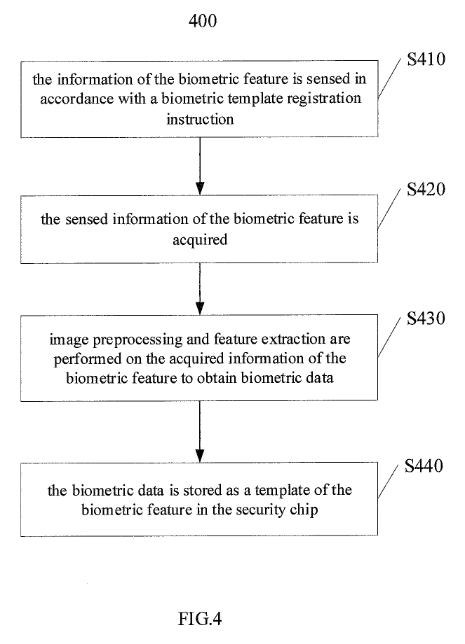

FIG. 4 shows a diagram of a biometric template registration method 400 according to an embodiment of the present disclosure. The method 400 may be entirely performed in a single security chip, such as the security chips 100 and 200 described above. The security chip may be installed in a computing device such as a smart phone or a tablet computer and the like, and physically isolated from the system environment of the computing device.

In step S410, the information of the biometric feature, such as fingerprint image information, is sensed in accordance with a biometric template registration instruction. The biometric template registration instruction can be provided by a computing device such as a smart phone, a tablet computer, or the like.

In step S420, the sensed information of the biometric feature is acquired.

In step S430, image preprocessing and feature extraction are performed on the acquired information of the biometric feature to obtain biometric data. For example, the information of the biometric feature may be preprocessed (e.g., image normalization, fingerprint effective area segmentation, fingerprint pattern processing, fingerprint enhancement processing, fingerprint binarization processing, fingerprint refinement processing, etc.) to obtain a grayscale image of the biometric feature, biometric points are extracted from the obtained grayscale image to obtain biometric data related to the biometric points, (e.g., biometric point data of a fingerprint).

In step S440, the biometric data is stored as a template of the biometric feature in the security chip. For example, the biometric data may be stored as a template of the biometric feature in a memory of the security chip, such as a non-volatile memory. Examples of non-volatile memory include, but are not limited to, a flash memory, an electrically erasable programmable read only memory (EEPROM), an erasable programmable read only memory (EPROM), a programmable read only memory (PROM), or other magnetic or electrical storage media where data can continue to be retained in the condition of power failure.

Embodiments of the present disclosure also provide a computer-readable storage medium storing instructions for performing the above method.

In the embodiments of the present disclosure, from the beginning of the sensing to the completion of the recognition, the information relative to the biometric feature is independently processed by a security chip that integrates a sensor, a memory and a processor, and physically isolates from the system environment of the computing device such as a smart phone, a tablet computer and the like. Compared with the traditional logic isolation, the security is greatly improved.

In the number of the present disclosure, the sensor, memory and processor are integrated in a security chip, so that the integration of a product is improved and the manufacturing cost and package size are reduced. Moreover, the size of the security chip is small relative to the sensor, and the sensor is integrated in the security chip to extend the functionality of the security chip, which will not lead to a big effect on the overall size of the security chip, so that the size of the final packaged security chip has a great advantage comparing to the size of a system in package (SiP).

Embodiments of the present disclosure can directly provide the biometric recognition result in a clear text (for example, in a high-level security system environment), and can also provide a digitally signed biometric recognition result in an open application environment to prevent the biometric recognition result output by the security chip from being tampered by Trojans or other viruses, so that behaviors which are not identified by fingerprint recognition will not be authorized. It can be seen that the embodiments of the present disclosure have a flexible implementation manner and the system environment can be configured to have different security levels in accordance with requirements.

The biometric recognition device according to the embodiment of the present disclosure can be installed in various computing devices, such as smart phones or tablet computers using Trust Zone security technique or Secure Enclave security technique. The biometric recognition result provided by the security chip can be transmitted in the non-security zone of the computing device (for example, if the system environment is relatively safe or the biometric recognition result has been signed), and certainly, the biometric recognition result can also be transmitted in the security zones to further improve the security. The biometric recognition device of the embodiment of the present disclosure can also be installed in a computing device that is not divided into security zones and non-security zones. It can be seen that the embodiments of the present disclosure are applicable to various existing computing devices such as smart phones, tablet computers, and thus have high compatibility.

The above description is merely exemplary embodiments of the present disclosure and is not intended to limit the scope of the present disclosure. The protection scope of the present disclosure is determined by the appended claims.

1. A security chip, comprising:
a sensor configured to sensor information of a biometric feature;
a memory configured to store a template of the biometric feature;
a processor configured to obtain the information of the biometric feature from the sensor, perform image preprocessing and feature extraction on the obtained information of the biometric feature, compare features with the template of the biometric feature stored in the memory to determine a biometric recognition result,
wherein the template of the biometric feature is generated by the processor by obtaining the information of the biometric feature from the sensor and performing image preprocessing and feature extraction on the obtained information of the biometric feature, and the sensor, the memory and the processor are integrated in the security chip.

2. The security chip according to claim 1, wherein the processor comprises:
an image obtaining module configured to obtain the information of the biometric feature from the sensor;
an image preprocessing module configured to preprocess the information of the biometric feature obtained by the image obtaining module to obtain a grayscale image of the biometric feature;
a feature extraction module configured to extract biometric points of the biometric feature from the grayscale image provided by the image preprocessing module to obtain biometric data relative to the biometric points; and
a feature comparison module configured to compare the biometric data provided by the feature extraction module with the template of the biometric feature stored in the memory and determine a biometric recognition result, wherein if the biometric data matches the template of the biometric feature, the biometric recognition result is passing, and otherwise, the biometric recognition result is failing.

3. The security chip according to claim 2, wherein the processor further comprises a signature module configured to digitally sign the biometric recognition result.

4. The security chip according to claim 1, wherein the security chip is a security element.

5. The security chip according to claim 1, wherein the security chip is installed in a computing device and is physically isolated from a system environment of the computing device.

6. The security chip according to claim 1, wherein the system environment of the computing device is divided into security zones and non-security zones, and the security chip sends the biometric recognition result to the computing device through the security zones or the non-security zones.

7. The security chip according to claim 1, wherein the biometric feature comprises a fingerprint, the information of the biometric feature comprises image information of the fingerprint, and the biometric data comprises biometric point data of the fingerprint, the template of the biometric feature includes a template of the fingerprint.

8. A biometric recognition method, comprising following steps performed in a single security chip:
sensing information of a biometric feature in accordance with a biometric recognition instruction;
obtaining the sensed information of the biometric feature;
performing image preprocessing and feature extraction on the obtained information of the biometric feature to obtain biometric data; and comparing the biometric data with a template of the biometric feature stored in the security chip to determine a biometric recognition result.

9. The biometric recognition method according to claim 8, further comprising: digitally signing the biometric recognition result in the security chip.

10. A biometric template registration method, comprising following steps performed in a single security chip:
sensing information of a biometric feature in accordance with a biometric template registration instruction;
obtaining the sensed information of the biometric feature;
performing image preprocessing and feature extraction on the obtained information of the biometric feature to obtain biometric data; and
storing the biometric data in the security chip as a template of the biometric feature.
